(19) United States
(12) Patent Application Publication
(10) Pub. No.: US 2001/0005954 A1
(43) Pub. Date: Jul. 5, 2001

(54) Bottom bouncer system

(76) Inventor: Douglas H. Hermanson, Mandan, ND (US)

Correspondence Address: Michael S. Neustel, Suite No. 4, 2534 South University Drive, Fargo, ND, 58103, US

(21) Appl. No.: 09/756,972

(22) Filed: Jan. 9, 2001

Related U.S. Application Data
(63) Continuation of application No. 09/400,704, filed on Sep. 20, 1999, now abandoned.

(51) Int. Cl. A01K 95/02

(52) U.S. Cl. 43/4.5; 43/43.1

(57) ABSTRACT

An improved bottom bouncer system for easily attaching to a fishing line and for reducing accumulation of debris upon the bottom bouncer. The inventive device includes a weight, an elongated upper member secured to the weight, an elongated lower member secured to the weight opposite of the upper member, a clip secured to the distal end of the upper member for securing to the fishing line, and an elongated sleeve secured about the upper member. The clip has a first jaw and a second jaw which are surrounded by a first sleeve and a second sleeve respectively. At least one tension band is positionable about the first jaw and the second jaw for allowing adjustment of the gripping force of the clip about the fishing line. The elongated sleeve provides a reduced resistant and broader surface that directs debris over the weight thereby preventing the debris from accumulating.

### CROSS-REFERENCE TO RELATED U.S. PATENT APPLICATION

I hereby claim benefit under Title 35, United States Code, Section 120 of U.S. patent application Ser. No. 09/400,704 filed Sep. 20, 1999. This application is a continuation of the Ser. No. 09/400,704 application. The Ser. No. 09/400,704 application is currently pending with a one-month extension of time filed to extend the patent pending period to Jan. 14, 2001. The Ser. No. 09/400,704 application is hereby incorporated by reference into this application.

### BACKGROUND OF THE INVENTION

1. Field of the Invention

The present invention relates generally to bottom bouncers and more specifically it relates to an improved bottom bouncer system for easily attaching to a fishing line and for reducing accumulation of debris upon the bottom bouncer.

Individuals that troll for fish often times desire to position the lure at a specified depth within the water above the lake bottom. Fishermen are capable of controlling this depth of the lure by providing a specified length of fishing line and controlling the velocity of the boat within the water. Unfortunately, it is very difficult for the fisherman to maintain a constant lure level within the water and the lure engages debris at the bottom of the lake including rocks and weeds. Hence, there is a need for a fishing system that maintains the lure at a desired water depth without accumulating or engaging debris within the water.

2. Description of the Prior Art

Bottom bouncers have been in use for years. Typically, a conventional bottom bouncer comprises a weight, an upper shaft, and a lower shaft. The upper shaft includes an attachment structure for securing to a fishing line a finite distance before the fishing lure. The lower shaft engages the lake bottom thereby supporting the fishing lure a finite distance above the lake bottom while the fisherman is trolling.

The main problem with conventional bottom bouncers is that they are extremely difficult to attach to a fishing line often times requiring the fisherman to tie knots within the fishing line. Another problem with conventional bottom bouncers is that debris such as weeds and fishing line become hooked upon the upper shaft just above the weight.

While these devices may be suitable for the particular purpose to which they address, they are not as suitable for easily attaching to a fishing line and for reducing accumulation of debris upon the bottom bouncer. Conventional bottom bouncers are not designed to be easily attached and removed to a fishing line. In addition, conventional bottom bouncers accumulate a significant amount of debris upon them such as weeds and grass.

In these respects, the improved bottom bouncer system according to the present invention substantially departs from the conventional concepts and designs of the prior art, and in so doing provides an apparatus primarily developed for the purpose of easily attaching to a fishing line and for reducing accumulation of debris upon the bottom bouncer.

### SUMMARY OF THE INVENTION

In view of the foregoing disadvantages inherent in the known types of bottom bouncers now present in the prior art, the present invention provides a new improved bottom bouncer system construction wherein the same can be utilized for easily attaching to a fishing line and for reducing accumulation of debris upon the bottom bouncer.

The general purpose of the present invention, which will be described subsequently in greater detail, is to provide a new improved bottom bouncer system that has many of the advantages of the bottom bouncers mentioned heretofore and many novel features that result in a new improved bottom bouncer system which is not anticipated, rendered obvious, suggested, or even implied by any of the prior art bottom bouncers, either alone or in any combination thereof.

To attain this, the present invention generally comprises a weight, an elongated upper member secured to the weight, an elongated lower member secured to the weight opposite of the upper member, a clip secured to the distal end of the upper member for securing to the fishing line, and an elongated sleeve secured about the upper member. The clip has a first jaw and a second jaw which are surrounded by a first sleeve and a second sleeve respectively. At least one tension band is positionable about the first jaw and the second jaw for allowing adjustment of the gripping force of the clip about the fishing line. The elongated sleeve provides a reduced resistant and broader surface that directs debris over the weight thereby preventing the debris from accumulating.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide an improved bottom bouncer system that will overcome the shortcomings of the prior art devices.

Another object is to provide an improved bottom bouncer system that is easily attachable and removable to and from a fishing line.

An additional object is to provide an improved bottom bouncer system that does not move about the fishing line during trolling.

A further object is to provide an improved bottom bouncer system that allows the user to adjust the amount of gripping force placed upon the fishing line.

Another object is to provide an improved bottom bouncer system that does not accumulate debris such as elongated plant growth.

A further object is to provide an improved bottom bouncer system that allows for infinite snell adjustment.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a side view of the present invention attached to a fishing line before a fishing lure.

FIG. 2 is a side view of the present invention.

FIG. 3 is an exploded side view of the present invention.

### DESCRIPTION OF THE PREFERRED EMBODIMENT

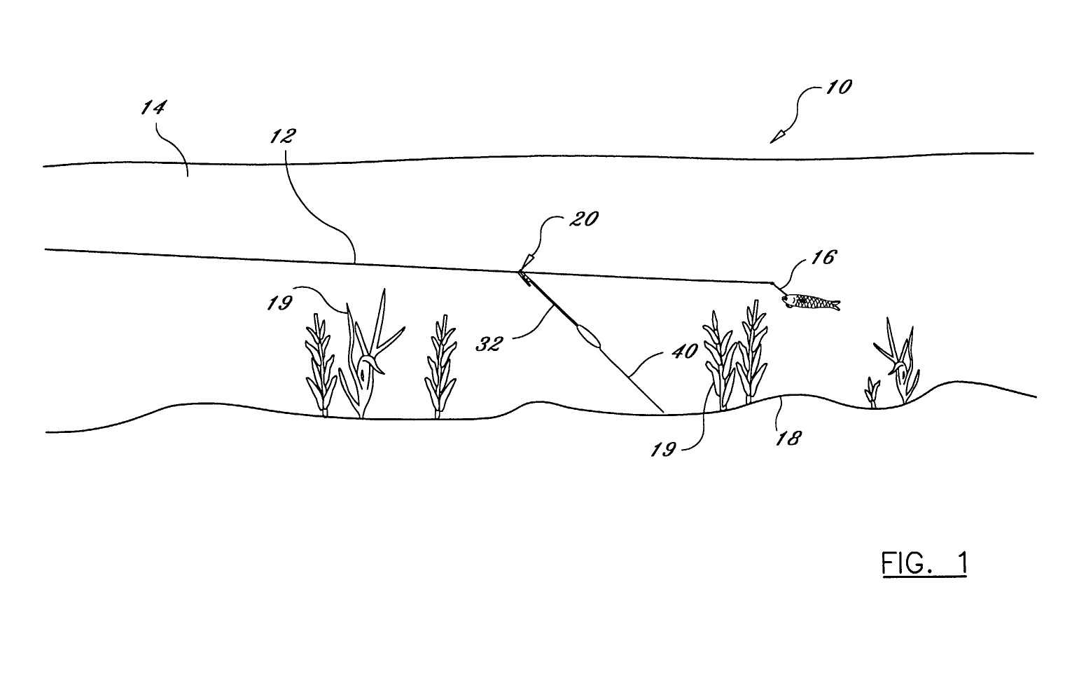

Turning now descriptively to the drawings, in which similar reference characters denote similar elements throughout the several view, FIGS. 1 through 3 illustrate an improved bottom bouncer system 10, which comprises a weight 50, an elongated upper member 30 secured to the weight 50, an elongated lower member 40 secured to the weight 50 opposite of the upper member 30, a clip 20 secured to the distal end of the upper member 30 for securing to the fishing line 12, and an elongated sleeve 32 secured about the upper member 30. The clip 20 has a first jaw 22 and a second jaw 24 which are surrounded by a first sleeve 60 and a second sleeve 62 respectively. At least one tension band 70 is positionable about the first jaw 22 and the second jaw 24 for allowing adjustment of the gripping force of the clip 20 about the fishing line 12. The elongated sleeve 32 provides a reduced resistant and broader surface that directs debris over the weight 50 thereby preventing the debris from accumulating.

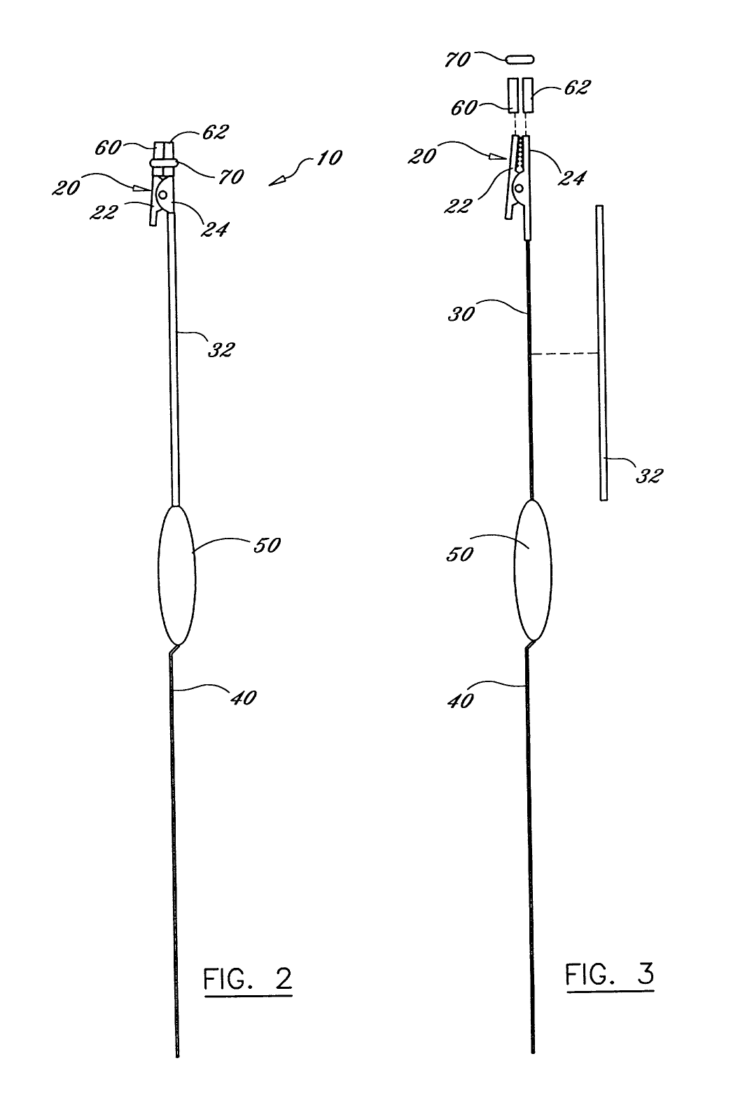

As best shown in FIGS. 2 and 3 of the drawings, a weight 50 is provided constructed of a heavy material such as lead or steel. The weight 50 preferably has an oblong shape, however it can be appreciated by one skilled in the art that various other shapes may be utilized to construct the weight 50.

As best shown in FIG. 3 of the drawings, an upper member 30 is secured to the weight 50. The upper member 30 is an elongated structure having a resilient structure. The upper member 30 is preferably constructed of a metal wire material, however various other materials may be utilized to construct the upper member 30. The upper member 30 is preferably molded into the weight 50, however various other attachment means may be utilized.

As best shown in FIGS. 2 and 3 of the drawings, a lower member 40 is secured to the weight 50 opposite of the upper member 30. The lower member 40 is an elongated structure having a resilient structure. The lower member 40 is preferably constructed of a metal wire material, however various other materials may be utilized to construct the lower member 40. The lower member 40 is preferably molded into the weight 50, however various other attachment means may be utilized. It can be appreciated that the lower member 40 and the upper member 30 may be connected to each other within the weight 50 or formed into one individual structure.

As shown in FIGS. 1 through 3 of the drawings, a clip 20 is secured to the distal end of the upper member 30 for removably securing to a fishing line 12. The clip 20 is comprised of a first jaw 22 and a second jaw 24 springably hinged together for engaging the fishing line 12 in front of the fishing lure 16. The jaws 22, 24 are constructed of a rigid material.

As best shown in FIGS. 2 and 3 of the drawings, a first sleeve 60 is positioned about the first jaw 22. The first sleeve 60 is constructed of a resilient material such as rubber for gripping the fishing line 12.

As shown in FIGS. 2 and 3 of the drawings, a second sleeve 62 is positioned about the second jaw 24 in opposition to the first sleeve 60. The second sleeve 62 is constructed of a resilient material such as rubber for gripping the fishing line 12 about the fishing line 12. When the jaws 22, 24 are closed, the sleeves 60, 62 are juxtaposed to one another for gripping the fishing line 12.

As best shown in FIGS. 2 and 3 of the drawings, at least one tension band 70 is provided that is positionable about the jaws 22, 24 and the sleeves 60, 62. The tension band 70 is constructed of a resilient rubber material for allowing the fisherman to increase the tension placed upon the fishing line 12 by the jaws 22, 24. If the user desires to increase the tension of the clip 20, the user simply adds additional tension bands 70.

As shown in FIGS. 1 through 3 of the drawings, an elongated sleeve 32 is positioned about the upper member 30. The elongated sleeve 32 is a tubular structure constructed of a material that allows debris such as plant growth 19 to slide off. The elongated sleeve 32 has an outer diameter broad enough to guide debris over the blunt end portion of the weight 50 that intersects the upper member 30 thereby preventing the debris from catching upon the weight 50 and the upper member 30.

In use, the user determines the location upon the fishing line 12 they desire to secure the clip 20 to depending upon the depth of the fishing lure 16 desired. The user then presses upon the jaws 22, 24 thereby opening the distal portion of the jaws 22, 24 for allowing the fishing line 12 to be positioned within the jaws 22, 24 and the sleeves 60, 62. The user then releases the jaws 22, 24 thereby allowing the jaws 22, 24 and the sleeves 60, 62 to close about and frictionally engage the fishing line 12 in the desired location. The user then may position at least one tension band 70 about the exterior portion of the clip 20 for adding additional forces upon the jaws 22, 24 thereby increasing the frictional engagement of the clip 20 about the fishing line 12. The user then extends the improved bottom bouncer system 10 along with the fishing line 12 and the fishing lure 16 into the water 14. The user then drives the boat in order to troll with the fishing lure 16 within the water 14. As the boat moves forwardly the lower end of the lower member 40 engages the lake bottom 18 thereby guiding the fishing line 12 and the fishing lure 16 a finite distance above the lake bottom 18 as shown in FIG. 1 of the drawings. As the inventive device moves through plant growth 19 and other debris, the plant growth 19 is diverted along the elongated sleeve 32 over the weight 50.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. An improved bottom bouncer system, comprising:
a resilient member having an elongated structure having a first end and a second end;
a weight attached to said resilient member thereby dividing said resilient member into a first portion and a second portion; and
a clip member secured to said first end of said resilient member for removably attaching to a fishing line.

2. The improved bottom bouncer system of claim 1, wherein said clip member includes:
a first jaw secured to said first end; and
a second jaw pivotally attached to said first jaw with a spring means for springably closing said second jaw with respect to said first jaw.

3. The improved bottom bouncer system of claim 2, including:
a first sleeve positioned about said first jaw; and
a second sleeve positioned about said second jaw in opposition to said first sleeve.

4. The improved bottom bouncer system of claim 3, wherein said first sleeve and said second sleeve are constructed of a resilient gripping material.

5. The improved bottom bouncer system of claim 2, including at least one tension band positionable about said first jaw and said second jaw for applying additional closing force upon said first jaw and said second jaw.

6. The improved bottom bouncer system of claim 5, wherein said at least one tension band is comprised of a resilient material.

7. The improved bottom bouncer system of claim 6, wherein said at least one tension band is comprised of a rubber material.

8. The improved bottom bouncer system of claim 7, including an elongated sleeve positioned about said upper portion of said resilient member.

9. The improved bottom bouncer system of claim 8, wherein said resilient member is comprised of a metal wire material.

10. The improved bottom bouncer system of claim 9, wherein said weight is an oblong structure.

11. An improved bottom bouncer system, comprising:
a weight;
a first resilient member having an elongated structure, wherein said first resilient member is secured to said weight;
a second resilient member having an elongated structure, wherein said second resilient member is secured to said weight opposite of said first resilient member; and
a clip member secured to a distal end of said first resilient member for removably attaching to a fishing line.

12. The improved bottom bouncer system of claim 11, wherein said clip member includes:
a first jaw secured to said distal end of said first resilient member; and
a second jaw pivotally attached to said first jaw with a spring means for springably closing said second jaw with respect to said first jaw.

13. The improved bottom bouncer system of claim 12, including:
a first sleeve positioned about said first jaw; and
a second sleeve positioned about said second jaw in opposition to said first sleeve.

14. The improved bottom bouncer system of claim 13, wherein said first sleeve and said second sleeve are constructed of a resilient gripping material.

15. The improved bottom bouncer system of claim 12, including at least one tension band positionable about said first jaw and said second jaw for applying additional closing force upon said first jaw and said second jaw.

16. The improved bottom bouncer system of claim 15, wherein said at least one tension band is comprised of a resilient material.

17. The improved bottom bouncer system of claim 16, wherein said at least one tension band is comprised of a rubber material.

18. The improved bottom bouncer system of claim 17, including an elongated sleeve positioned about said first resilient member.

19. A method of utilizing a bottom bouncer system having a resilient member, a weight attached to said resilient member, a clip member having a first jaw and a second jaw attached to said resilient member, and at least one tension band, said method comprising the steps of:
(a) opening said clip member;
(b) positioning a portion of a fishing line between said first jaw and said second jaw of said clip member;
(c) closing said clip member about said fishing line; and
(d) positioning said at least one tension band about said first jaw and said second jaw for applying an increased gripping force upon said fishing line by said clip member.

20. The method of utilizing a bottom bouncer system of claim 19, wherein said step of positioning said portion of said fishing line comprises wrapping said fishing line at least one revolution about said first jaw.
